(19) United States
(12) Patent Application Publication
(10) Pub. No.: US 2019/0204765 A1
(43) Pub. Date: Jul. 4, 2019

(54) FIXING APPARATUS AND IMAGE FORMING APPARATUS

(71) Applicant: KYOCERA Document Solutions Inc., Osaka (JP)

(72) Inventor: Kanako MORIMOTO, Osaka-shi (JP)

(73) Assignee: KYOCERA Document Solutions Inc., Osaka (JP)

(21) Appl. No.: 16/191,165

(22) Filed: Nov. 14, 2018

(30) Foreign Application Priority Data
Jan. 4, 2018 (JP) 2018-000105

(51) Int. Cl. G03G 15/20

(52) U.S. Cl. CPC G03G 15/2025; G03G 15/2064

(57) ABSTRACT

A fixing apparatus includes: a fixing belt; a pressing member pushing the fixing belt from an outer face side of the fixing belt; a pushing member positioned inside the fixing belt and pushing the fixing belt from an inner face side of the fixing belt toward a side where the pressing member is located; a sheet-shaped heater positioned between the inner face of the fixing belt and the pushing member, provided with a substrate and a heating element placed on the substrate, and heating the fixing belt; and a lubricant holding part holding lubricant, and positioned between the sheet-shaped heater and the pushing member, or positioned in a part facing the sheet-shaped heater, of the pushing member, wherein a lubricant passage supplying the lubricant held by the lubricant holding part to the inner face of the fixing belt is formed in the substrate.

### INCORPORATION BY REFERENCE

This application is based on and claims the benefit of priority from Japanese Patent application No. 2018-000105 filed on Jan. 4, 2018, which is incorporated by reference in its entirety.

### BACKGROUND

The present disclosure relates to a fixing apparatus configured to fix a toner image to a recording medium and an image forming apparatus with the fixing apparatus.

In general, an electrophotographic image forming apparatus, such as a copier, a printer or the like, includes a fixing apparatus configured to fix a toner image to a recording medium, such as a sheet of paper.

A fixing apparatus including a fixing belt, a pressing member touching and pushing the outer face of the fixing belt, a pushing member positioned inside the fixing belt and pushing the fixing belt towards the side where the pressing member is located, and a sheet member positioned between the pushing member and the fixing belt and slidably touching the inner face of the fixing belt is known. The sheet member is impregnated with lubricant. The fixing apparatus is configured to supply the lubricant to the inner face of the fixing belt from the sheet member.

A heater of the fixing apparatus is positioned on the upper side of the rotation axis of the fixing belt in the area inside the fixing belt, radiates heat from a position away from the inner face of the fixing belt, and heats the fixing belt mainly when the fixing belt passes through the upper side of the heater.

In contrast to this, among fixing apparatuses, there is a fixing apparatus in which a sheet-shaped heater is placed between the pushing member and the fixing belt, specifically, at a position where the pushing member pushes the fixing belt towards the side where the pressing member is located. In such a fixing apparatus, the sheet-shaped heater slidably touches the inner face of the fixing belt and directly heats the fixing belt. Therefore, it is difficult to supply lubricant to the inner face of the fixing belt by using the sheet member impregnated with the lubricant, like the aforementioned fixing apparatus. If the supply of the lubricant to the inner face of the fixing belt is insufficient, friction between the inner face of the fixing belt and the sheet-shaped heater increases. This obstructs conveyance of recording media or makes the life of the fixing apparatus shorter.

### SUMMARY

A fixing apparatus of the present disclosure includes: a fixing belt; a pressing member pushing the fixing belt from an outer face side of the fixing belt; a pushing member positioned inside the fixing belt and pushing the fixing belt from an inner face side of the fixing belt toward a side where the pressing member is located; a sheet-shaped heater positioned between the inner face of the fixing belt and the pushing member, provided with a substrate and a heating element placed on the substrate, and heating the fixing belt; and a lubricant holding part holding lubricant, and positioned between the sheet-shaped heater and the pushing member, or positioned in a part facing the sheet-shaped heater, of the pushing member, wherein a lubricant passage supplying the lubricant held by the lubricant holding part to the inner face of the fixing belt is formed in the substrate.

An image forming apparatus of the present disclosure, an image forming apparatus of the present disclosure includes the fixing apparatus of the present disclosure.

Other features, advantages and objects of the fixing apparatus and the image forming apparatus of the present disclosure will become clear to those skilled in the art from the following description and the accompanying drawings.

### BRIEF DESCRIPTION OF THE DRAWINGS

FIG. 1 is an explanation view showing a printer of an embodiment of the image forming apparatus of the present disclosure.

FIG. 2 is an explanation view showing an embodiment of the fixing apparatus of the present disclosure.

FIG. 3 is a sectional view showing a pushing member, a sheet-shaped heater, a lubricant holding part and so on in the embodiment of the fixing apparatus of the present disclosure.

FIG. 4 is a sectional view showing the sheet-shaped heater, the lubricant holding part and so on taken along line IV-IV of FIG. 3.

FIG. 5 is a sectional view showing the sheet-shaped heater, the lubricant holding part and so on taken along line V-V of FIG. 3.

FIG. 6 is an explanation view showing the sheet-shaped heater taken along line VI-VI of FIG. 3.

FIG. 7 is an explanation view showing a first modification of the sheet-shaped heater of the embodiment of the fixing apparatus of the present disclosure.

FIG. 8 is an explanation view showing a second modification of the sheet-shaped heater of the embodiment of the fixing apparatus of the present disclosure.

FIG. 9 is an explanation view showing a third modification of the sheet-shaped heater of the embodiment of the fixing apparatus of the present disclosure.

FIG. 10 is a table showing results of measuring the torque of a pressing roller in experiments on the sheet-shaped heater of the embodiment of the fixing apparatus of the present disclosure; the first, second and third modifications of the sheet-shaped heater; and so on.

FIG. 11 is a sectional view showing a modification of the lubricant holding part of the embodiment of the fixing apparatus of the present disclosure.

### DETAILED DESCRIPTION

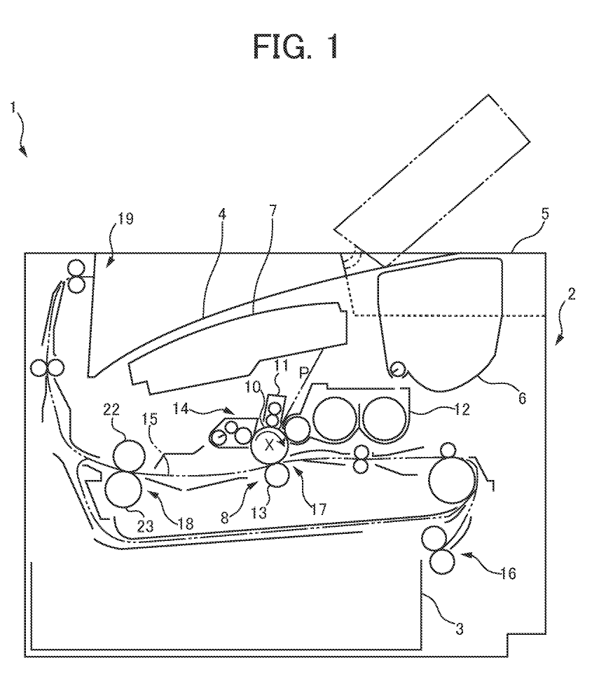

FIG. 1 shows a structure of the whole of a printer 1, which corresponds to an image forming apparatus. In FIG. 1, the printer 1 has a box-shaped casing 2. A paper feeding cassette 3 is placed in a lower portion of the casing 2. The paper feeding cassette 3 stores paper, which corresponds to recording media. A paper ejection tray 4 is placed at an upper portion of the casing 2. A toner container installation part is formed in an upper-right portion of the casing 2. A toner container 6 is placed in the toner container installation part. An upper cover 5 is placed at the upper-right portion of the casing 2. The toner container placing part is opened and closed by the upper cover 5. Toner is stored in the toner container 6. Toner is supplied to a development device 12.

An exposure device 7 and an image forming unit 8 are placed in the casing 2. The image forming unit 8 has a photosensitive drum 10, a charger 11, the development device 12, a transfer roller 13 and a cleaning device 14. The charger 11 charges a surface of the photosensitive drum 10. The exposure device 7 irradiates the surface of the photosensitive drum 10 with a laser beam P to form an electrostatic latent image on the surface of the photosensitive drum 10. The development device 12 forms a toner image corresponding to the latent image on the surface of the photosensitive drum 10. The transfer roller 13 transfers the toner image onto a sheet of paper. The cleaning device 14 retrieves the toner remaining on the surface of the photosensitive drum 10 after the toner image is transferred to the paper.

A conveying path 15 for paper is formed in the casing 2. A paper feeder 16 for feeding a sheet of paper stored in the paper feeding cassette 3, a transferring unit 17 for transferring a toner image onto a sheet of paper, and a paper ejection unit 19 for ejecting a sheet of paper to the paper ejection tray 4 after a toner image is fixed to the paper are positioned on the conveying path 15. A sheet of paper fed onto the conveying path 15 by the paper feeder 16 is conveyed to the transferring unit 17, and supplied between the photosensitive drum 10 and the transfer roller 13 by the transferring unit 17. When the paper passes through between the photosensitive drum 10 and the transfer roller 13, a toner image formed on the surface of the photosensitive drum 10 is transferred onto the paper. Thereafter, the paper is conveyed to a fixing apparatus 18, which is positioned on a downstream side of the image forming unit 8 on the conveying path 15 in a paper conveyance direction, as mentioned later, and supplied between a fixing belt 22 and a pressing roller 23. When the paper passes through between the fixing belt 22 and the pressing roller 23, the toner image is fixed to the paper. Thereafter, the paper is conveyed to the paper ejection unit 19, and then ejected to the paper ejection tray 4.

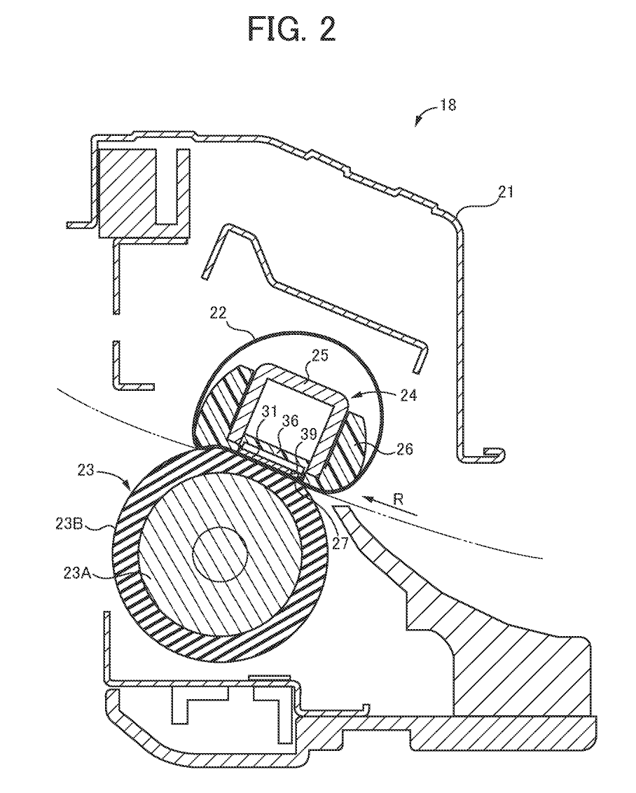

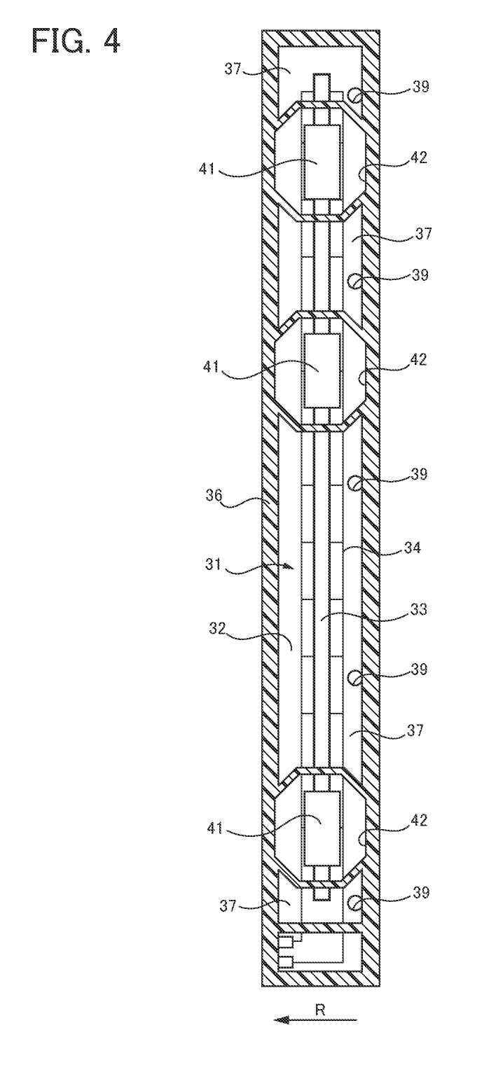

FIG. 2 shows the fixing apparatus 18, which is an embodiment of the fixing apparatus of the present disclosure. As shown in FIG. 2, the fixing apparatus 18 has a frame part 21, the fixing belt 22, the pressing roller 23, which corresponds to a pressing member, a pushing member 24, a sheet-shaped heater 31, a lubricant holding part 36, a lubricant passage (a supply hole 39), and thermistors 41 (see FIG. 4).

The whole shape of the frame part 21 is like a box. The frame part 21 forms an outer shell of the fixing apparatus 18.

The fixing belt 22 is a member for heating a toner image on a sheet of paper and positioned in the frame part 21. The fixing belt 22 is an endless belt, has a cylindrical shape, and has flexibility. The fixing belt 22 has a base layer, an elastic layer and a release layer, which are superposed in this order from an inner face to an outer face of the fixing belt 22. These layers are not individually depicted in the drawings. The base layer is made of, for example, metal, such as stainless steel, or resin, such as polyimide. The elastic layer is made of, for example, silicon rubber. The release layer is made of fluororesin or the like.

The pressing roller 23 is a member for pushing or pressing the fixing belt 22 from an outer face side of the fixing belt 22 and positioned below the fixing belt 22 in the frame part 21. The pressing roller 23 is shaped like a cylinder. A core 23A of the pressing roller 23 is made of metal, such as iron. An elastic layer 23B made of silicon rubber or the like is positioned on an outer circumferential side of the core 23A. A release layer (not depicted) made of fluororesin or the like is positioned on an outer circumferential face of the elastic layer 23B. Both of end parts of the core 23A of the pressing roller 23 in an axial direction of the pressing roller 23 are supported by the frame part 21 so as to be able to move in an up and down direction, and energized upwards by an energizing device (not depicted), such as a spring, placed in the frame part 21.

The pushing member 24 is a member for pushing the fixing belt 22 towards the pressing roller 23 from an inner face side of the fixing belt 22 and positioned on an inside (the inner face side) of the fixing belt 22. The pushing member 24 has a pillar part 25 forming a skeleton of the pushing member 24, and a belt supporting part 26 attached to the pillar part 25. The fixing belt 22 is slidably supported between the pressing roller 23 and the belt supporting part 26. The pillar part 25 is made of stainless steel, iron or another material with high stiffness. The pillar part 25 is shaped like a pillar or pipe and extends in an axial direction of the fixing belt 22. In this embodiment, the pillar part 25 is formed in the shape of a pillar with a cross section shaped like KO, which is a Japanese character similar to “U” in shape. Both of end parts of the pillar part 25 in an axial direction of the pillar part 25 are fixed to the frame part 21. The belt supporting part 26 is made of, for example, resin, such as liquid crystal polymer. The belt supporting part 26 covers a left side portion, a lower side portion and a right side portion of the pillar part 25 in FIG. 2, and extends from one end to the other end of the pillar part 25 in the axial direction of the pillar part 25.

A heater placing part 27 for placing the sheet-shaped heater 31 is formed in a center portion of a lower face of the belt supporting part 26 in a left and right direction in FIG. 2. The heater placing part 27 is formed by hollowing a part of the lower face of the belt supporting part 26. The heater placing part 27 is shaped like a concave opened downwards. The heater placing part 27 is formed in a part from one end to the other end of the belt supporting part 26 in an axial direction of the belt supporting part 26 in the lower face of the belt supporting part 26.

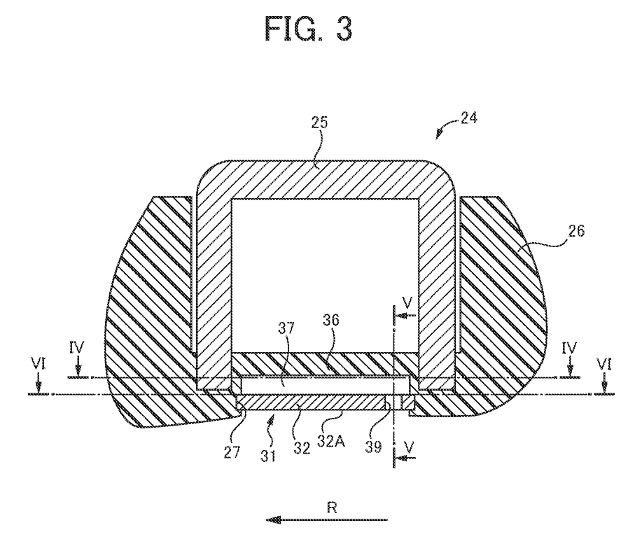

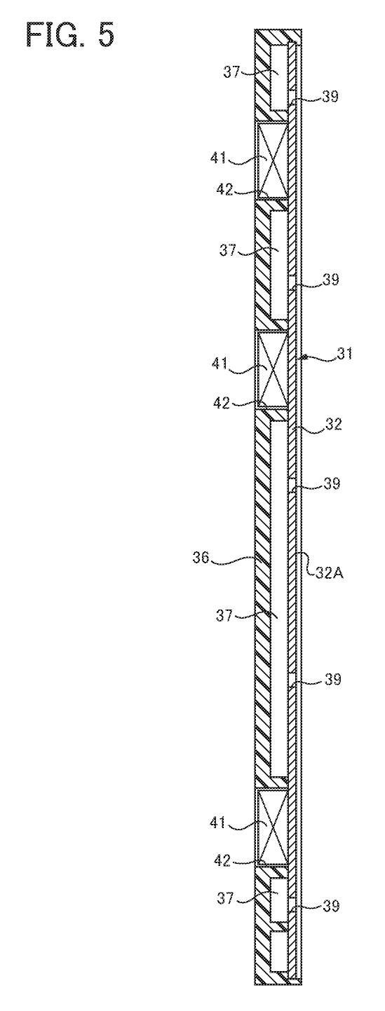

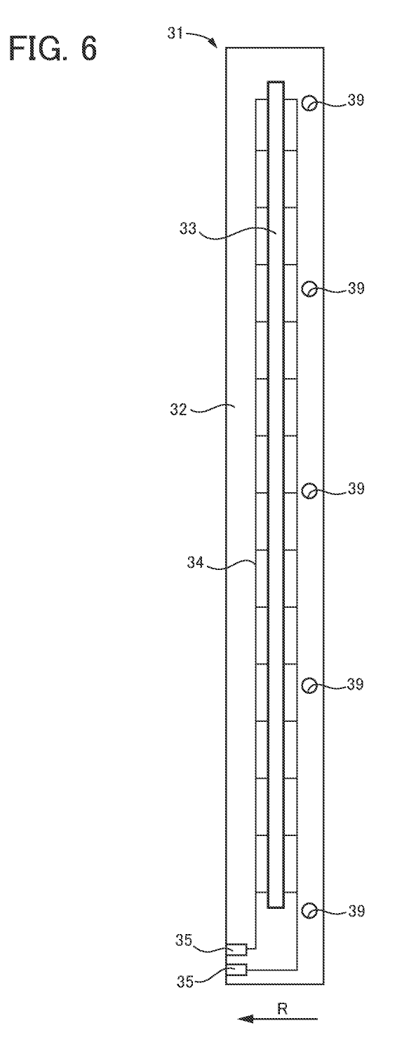

FIG. 3 shows the pushing member 24, the sheet-shaped heater 31, the lubricant holding part 26 and so on. FIG. 4 shows the sheet-shaped heater 31, the lubricant holding part 36 and so on taken along line IV-IV of FIG. 3. FIG. 5 shows the sheet-shaped heater 31, the lubricant holding part 36 and so on taken along line V-V of FIG. 3. FIG. 6 shows the sheet-shaped heater 31 and so on taken on line VI-VI of FIG. 3.

The sheet-shaped heater 31 is a heat source for heating the fixing belt 22. The sheet-shaped heater 31 is placed inside the heater placing part 27, as shown in FIG. 3, and positioned between the inner face of the fixing belt 22 and the belt supporting part 26, as shown in FIG. 2. The sheet-shaped heater 31 has a substrate 32, a heating element 33 formed on an upper face of the substrate 32, an electric circuit 34 for supplying an electric current to the heating element 32, and a pair of terminal parts 35 for applying a voltage to the electric circuit 34, as shown in FIG. 6.

The substrate 32 is shaped like a flat board in the shape of a long, narrow rectangle, and extends from one end to the other end of the belt supporting part 26 in the axial direction of the belt supporting part 26. The substrate 32 is supported inside the heater placing part 27, for example, by the way of inserting end parts of the substrate 32 into grooves formed in inner side faces of the heater supporting part 27. When the fixing belt 22 is pushed by the pressing roller 23, the inner face of the fixing belt 22 touches a lower face 32A (see FIG. 5) of the substrate 32.

The heating element 33 is formed of an electrically heated wire which generates heat when an electric current is supplied to the electrically heated wire. As shown in FIG. 6, the heating element 33 is positioned on a center portion of an upper face of the substrate 32 in a width direction of the substrate 32 and extends one end to the other end of the substrate 32 in a longitudinal direction of the substrate 32. A coating is formed on the upper face of the substrate 32 so as to cover an upper face of the heating element 33. The electric circuit 34 is positioned on a center portion of the substrate 32 in the width direction of the substrate 32, and each of the terminal parts 35 is positioned at a corner portion of the substrate 32.

The lubricant holding part 36 is a part for holding lubricant. The lubricant is supplied to the inner face of the fixing belt 22 in order to reduce friction mainly generated between the inner face of the fixing belt 22 and the lower face 32A of the substrate 32 of the sheet-shaped heater 31. As shown in FIGS. 3 to 5, the lubricant holding part 36 is positioned in a part facing the sheet-shaped heater 31, of the belt supporting part 26. As shown in FIG. 5, the lubricant holding part 36 has multiple storage rooms 37 for storing the lubricant. Each of the storage rooms 37 is formed by covering an opening of a downward concave part formed in a bottom face of the heater supporting part 27 with the substrate 32. Each of the storage rooms 37 is positioned at a place different from places where thermistor placing parts 42, which are mentioned later, are positioned so as to avoid the thermistor placing parts 42. The lubricant is silicon system oil or grease, for example.

The lubricant passage is a passage for supplying the lubricant stored in the storage rooms 37 to the inner face of the fixing belt 22. As show in FIG. 6, the lubricant passage of this embodiment is formed by multiple supply holes 39 each of which penetrates the substrate 32. Each of the supply holes 39 is positioned at a place corresponding to any one of the storage rooms 37 and connected to any one of the storage rooms 37. Each of the supply holes 39 is positioned on an upstream side of the heater element 33 in the paper conveyance direction, which is shown by arrow R. Each of the supply holes 39 is positioned at an end part of the substrate 32 in the width direction of the substrate 32, specifically an end part of the substrate 32 located on the upstream side of the paper conveyance direction. In the substrate 32, each of the supply holes 39 is positioned approximately 0.5 mm or more, specifically approximately 0.7 mm or more, away from each of the heating element 33, the electric circuit 34 and the terminal parts 35.

Each of the thermistors 41 is a sensor for detecting the temperature of the sheet-shaped heater 31. The fixing apparatus 18 of this embodiment has three thermistors 41. As shown in FIG. 5, the thermistors 41 are positioned in the thermistor placing parts 42, respectively. Each of the thermistor placing parts 42 is a hole formed at a portion facing the sheet-shaped heater 31, of the belt supporting part 26, and penetrates the portion in the up and down direction. Each of the thermistor 41 touches or facing a portion where the heating element 33 is located, of the upper face of the substrate 32.

The fixing apparatus 18 having the aforementioned structure performs an operation mentioned below. In FIG. 2, the pressing roller 23 is energized upwards by the aforementioned energizing device and pushes or presses the fixing belt 22 and the pushing member 24 upwards from the outer face side of the fixing belt 22. The pushing member 24 receives pressure from the pressing roller 23 and pushes the fixing belt 22 and the pressing roller 23 downwards from the inner face side of the fixing belt 22 with reaction force corresponding to the pressure from the pressing roller 23. As a result, the outer face of the pressing roller 23 and the outer face of the fixing belt 22 push each other, so that a nip is formed at the part where they push each other. Simultaneously with this, the inner face of the fixing belt 22 touches the lower face 32A of the substrate 32 of the sheet-shaped heater 31.

In this state, the pressing roller 23 is rotated in a counterclockwise direction in FIG. 2. With friction between the pressing roller 23 and the outer face of the fixing belt 22, the fixing belt 22 rotates in a clockwise direction in FIG. 2. As a result, the inner face of the fixing belt 22 slides on the lower face 32A of the substrate 32 of the sheet-shaped heater 31. In this state, a voltage is applied to the sheet-shaped heater 31, so that the heating element 33 generates heat and the fixing belt 22 is heated.

Thereafter, when a sheet of paper on which a toner image is transferred passes through a portion between the outer face of the pressing roller 23 and the outer face of the fixing belt 22, namely the nip, in the direction shown by arrow R in FIG. 2, the toner image on the paper is melted, pressed onto the paper and fixed to the paper.

While the inner face of the fixing belt 22 slides on the lower face 32A of the substrate 32 of the sheet-shaped heater 31, the lubricant is supplied to the inner face of the fixing belt 22 from the storage rooms 37 through the supply holes 39. As a result, the inner face of the fixing belt 22 is continuously lubricated, so that friction between the inner face of the fixing belt 22 and the lower face 32A of the substrate 32 and friction between the inner face of the fixing belt 22 and the lower face of the belt supporting part 26 are reduced.

As described above, in the fixing apparatus 18, the lubricant holding part 36 is placed at the portion facing the sheet-shaped heater 31, of the belt supporting part 26 of the pushing member 24, and the lubricant passage (the supply holes 39) is formed in the substrate 32 of the sheet-shaped heater 31. According to this structure, it is possible to sufficiently supply the lubricant to the inner face of the fixing belt 22, even in the case where it is difficult to place a sheet member and the like impregnated with lubricant in a portion where the inner face of the fixing belt and the belt supporting part touch each other because the sheet-shaped heater is placed there. By supplying the lubricant to the inner face of the fixing belt 22 sufficiently, it is possible to restrict increase of friction between the inner face of the fixing belt 22 and the sheet-shaped heater 31. Therefore, it is possible to prevent the conveyance of paper from being obstructed due to increase of torque of the pressing roller 23. Further, it is possible to reduce a load of the fixing apparatus 18 while the fixing apparatus 18 operates, and therefore, it is possible to prolong the life of the fixing apparatus 18.

Further, in the fixing apparatus 18, the storage rooms 37 are formed in the part facing the sheet-shaped heater 31, of the belt supporting part 26, and the lubricant is stored in the storage rooms 37. According to this structure, it is possible to hold an enough amount of the lubricant to continuously lubricate the inner face of the fixing belt 22 for a long time. Further, each of the storage rooms 37 is positioned near the fixing belt 22. Therefore, it is possible to supply the lubricant stored in the storage rooms 37 to the inner face of the fixing belt 22 smoothly.

Furthermore, each of the storage rooms 37 is formed by covering the opening of the concave part formed in the face facing the sheet-shaped heater 31, of the pushing member 24, with the substrate 32. According to this structure, it is possible to make the structure of each of the storage rooms 37 simple.

Furthermore, the lubricant passage for supplying the lubricant stored in the storage rooms 37 to the inner face of the fixing belt 22 is formed by the supply holes 39 each of which penetrates the substrate 32 and positioned at a place corresponding to any one of the storage rooms 37. According to this structure, it is possible to form the lubricant passage easily. Furthermore, by selecting the number of supply holes 39 or the diameter of each supply hole 39, the amount of the lubricant which is supplied to the inner face of the fixing belt 22 can be easily adjusted. Furthermore, the multiple supply holes 39 are spread out in the substrate 32. Therefore, it is possible to supply the lubricant to the whole of the inner face of the fixing belt 22 uniformly.

Moreover, each of the supply holes 39 is positioned on the upstream side of the heating element 33 in the paper conveyance direction. According to this structure, it is possible to place the lubricant between the inner face of the fixing belt 22 and the lower face 32A of the substrate 32 of the sheet-shaped heater 31 and enhance the effect of restricting increase of friction between the inner face of the fixing belt 22 and the lower face 32A of the substrate 32.

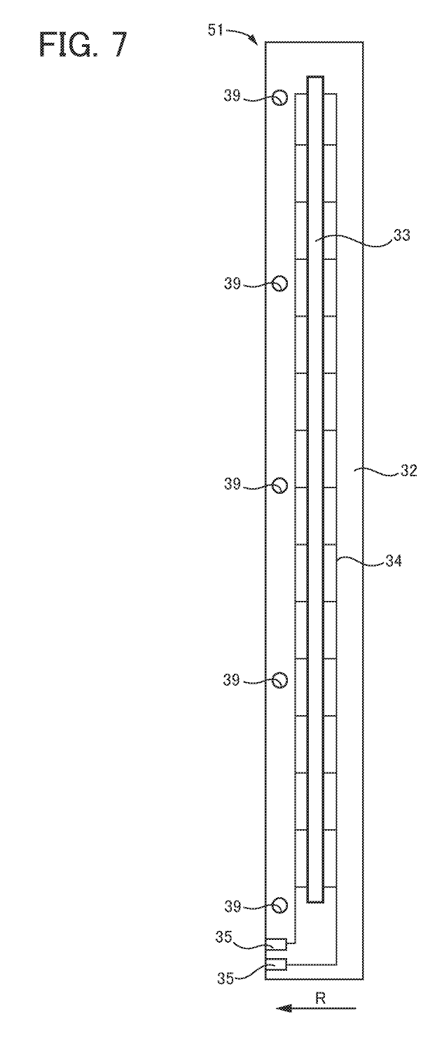

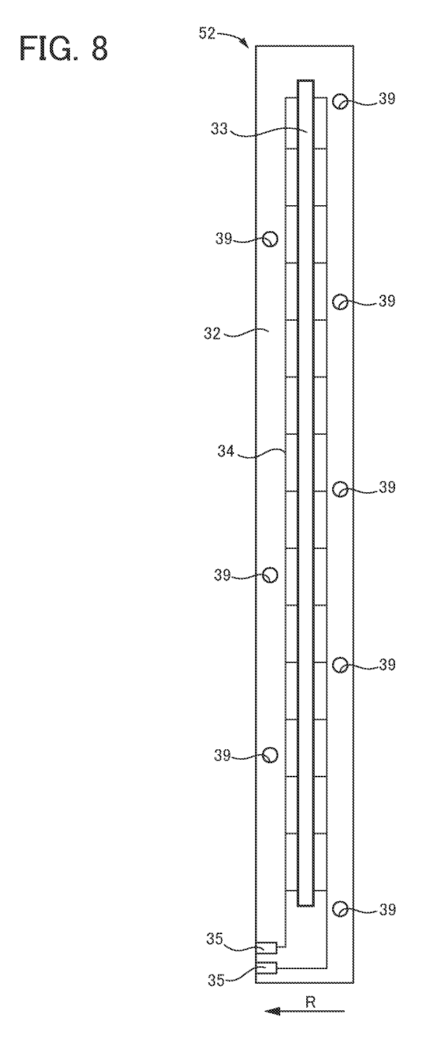

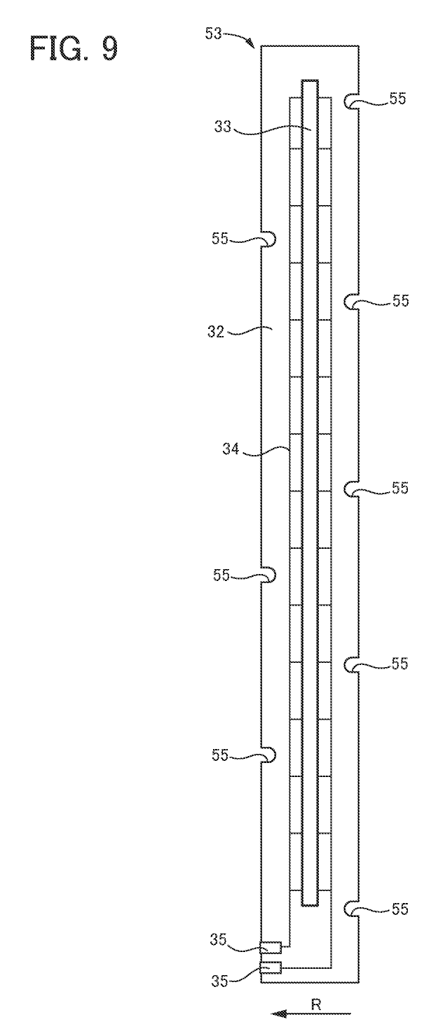

FIGS. 7 to 9 show three modifications of the sheet-shaped heater of the embodiment of the fixing apparatus of the present disclosure. As shown in FIG. 6, in the sheet-shaped heater 31 in the above-described embodiment of the fixing apparatus of the present disclosure, the supply holes 39 forming the lubricant passage are positioned on the upstream side of the heating element 33 in the paper conveyance direction (shown by arrow R). In contrast, as shown in FIG. 7, in a sheet-shaped heater 51 of the first modification, the supply holes 39 are positioned on the downstream side of the heating element 33 in the paper conveyance direction. Further, as shown in FIG. 8, in a sheet-shaped heater 52 of the second modification, the supply holes 39 are positioned on the upstream side and the downstream side of the heating element 33 in the paper conveyance direction. Furthermore, as shown in FIG. 9, in a sheet-shaped heater 53 of the third modification, the lubricant passage is formed by multiple notches 55 formed in both end faces of the substrate 32 of the sheet-shaped heater 53. In the sheet-shaped heater 53, each of the notches 55 is positioned at a portion corresponding to any one of the storage rooms 37, of the substrate 32. Further, the notches 55 are positioned on the upstream side and the downstream side of the heating element 33 in the paper conveyance direction.

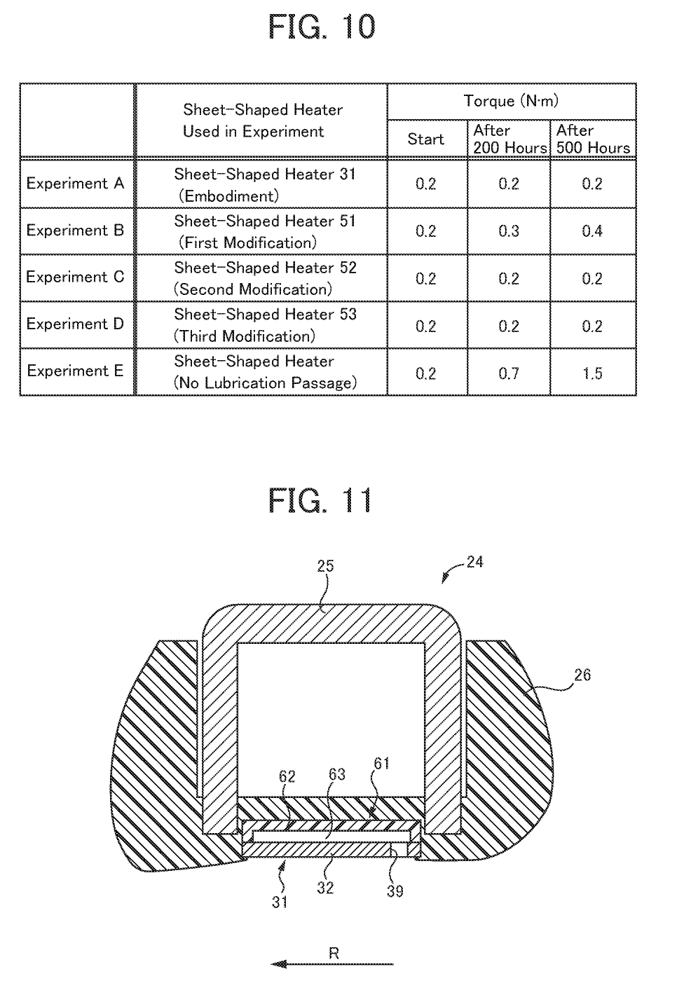

FIG. 10 shows the results of measuring the torque of the pressing roller 23 in experiments on the sheet-shaped heaters 31, 51, 52, 53 and so on. In experiment A shown in FIG. 10, continuous printing was carried out for not less than 500 hours, while the surface temperature of the fixing belt 22 is kept at approximately 175° C., by using the fixing apparatus 18 in which the sheet-shaped heater 31 is attached to the heater placing part 27. The lubricant was sufficiently applied between the inner face of the fixing belt 22 and the lower face 32A of the substrate 32 of the sheet-shaped heater 31 immediately before the continuous printing was started. In experiment B, the continuous printing was carried out under the same conditions as those of the experiment A by using the fixing apparatus 18 in which the sheet-shaped heater 51 is attached to the heater placing part 27. In experiment C, the continuous printing was carried out under the same conditions as those of the experiment A by using the fixing apparatus 18 in which the sheet-shaped heater 52 is attached to the heater placing part 27. In experiment D, the continuous printing was carried out under the same conditions as those of the experiment A by using the fixing apparatus 18 in which the sheet-shaped heater 53 is attached to the heater placing part 27. In experiment E, the continuous printing was carried out under the same conditions as those of the experiment A by using the fixing apparatus in which a sheet-shaped heater not having any lubricant passage is attached to the heater placing part 27.

In experiment A, the torque at the time when the continuous printing was started is maintained after 500 hours from the time when the continuous printing was started. This means that, while the continuous printing was done, the lubricant was sufficiently supplied to the inner face of the fixing belt 22, so that increase of friction between the inner face of the fixing belt 22 and the lower face 32A of the substrate 32 of the sheet-shaped heater 31 was restricted.

In experiment B, the torque increased by a small amount with the passage of time. This means that, while the continuous printing was done, friction between the inner face of the fixing belt 22 and the lower face of the substrate of the sheet-shaped heater 51 increased slightly.

In experiment C, like the result of experiment A, the torque at the time when the continuous printing was started is maintained after 500 hours from the time when the continuous printing was started. Moreover, in experiment D, like the result of experiment A, the torque at the time when the continuous printing was started is maintained after 500 hours from the time when the continuous printing was started.

In experiment E, the torque considerably increased with the passage of time. This means that, while the continuous printing was done, the lubricant on the inner face of the fixing belt 22 had been used up, so that friction between the inner face of the fixing belt 22 and the lower face of the substrate of the sheet-shaped heater greatly increased.

As seen from the comparison between each of the results of experiments A to D and the result of experiment E, the lubricant can be supplied to the inner face of the fixing belt 22 sufficiently by forming the lubricant passage (the supply holes 39 or the notches 55) in the substrate of the sheet-shaped heater. Therefore, increase of friction between the inner face of the fixing belt 22 and the sheet-shaped heater can be restricted.

Further, as seen from the comparison between the result of experiment A and the result of experiment B, the lubricant can be surely placed between the inner face of the fixing belt 22 and the lower face of the substrate of the sheet-shaped heater by using the sheet-shaped heater 31 in which the lubricant passage (the supply holes 39) is formed on the upstream side of the heating element 33. Therefore, increase of friction between the inner face of the fixing belt 22 and the sheet-shaped heater can be surely restricted by using the sheet-shape heater 31.

Furthermore, as seen from the comparison between the result of experiment A and the result of experiment C, the lubricant can be surely placed between the inner face of the fixing belt 22 and the lower face of the substrate of the sheet-shaped heater by using the sheet-shaped heater 52 in which the lubricant passage (the supply holes 39) is formed on both of the upstream side and the downstream side of the heating element 33. Therefore, increase of friction between the inner face of the fixing belt 22 and the sheet-shaped heater can be surely restricted by using the sheet-shape heater 52.

Moreover, as seen from the comparison between the result of experiment C and the result of experiment D, the lubricant can be surely placed between the inner face of the fixing belt 22 and the lower face of the substrate of the sheet-shaped heater by using the sheet-shaped heater 53 in which the lubricant passage is formed by the notches 55 formed in the end faces of the substrate 32. Therefore, increase of friction between the inner face of the fixing belt 22 and the sheet-shaped heater can be surely restricted by using the sheet-shape heater 53.

Incidentally, in the aforementioned embodiment, as shown in FIG. 3, the belt supporting part 26 and the lubricant holding part 36 are formed by a single member. Alternatively, as shown in FIG. 11, a lubricant holding part 61 may be formed by placing a board-shaped member 62 separated from the belt supporting part 26 between the belt supporting part 26 and the sheet-shaped heater 31. The board-shaped member 62 is shaped like a long flat board extending from one end to the other end of the belt supporting part 26 in the axial direction of the belt supporting part 26. A downward concave part is formed in a lower face of the board-shaped member 62. A storage room 63 for storing the lubricant is formed by covering the concave parts with the substrate 32.

Further, the number of supply holes 39 and the number of notches 55 are not limited. Furthermore, an image forming apparatus of the present disclosure is not limited to a printer. The present disclosure can be applied to another type of image forming apparatus, such as a copier, a facsimile machine or a multifunction peripheral.

While the preferable embodiment and its modified example of the fixing device and the image forming apparatus of the present disclosure have been described above and various technically preferable configurations have been illustrated, a technical range of the disclosure is not to be restricted by the description and illustration of the embodiment. Further, the components in the embodiment of the disclosure may be suitably replaced with other components, or variously combined with the other components. The claims are not restricted by the description of the embodiment of the disclosure as mentioned above.

What is claimed is:

1. A fixing apparatus comprising:
a fixing belt;
a pressing member pushing the fixing belt from an outer face side of the fixing belt;
a pushing member positioned inside the fixing belt and pushing the fixing belt from an inner face side of the fixing belt toward a side where the pressing member is located;
a sheet-shaped heater positioned between the inner face of the fixing belt and the pushing member, provided with a substrate and a heating element placed on the substrate, and heating the fixing belt; and
a lubricant holding part holding lubricant, and positioned between the sheet-shaped heater and the pushing member, or positioned in a part facing the sheet-shaped heater, of the pushing member,
wherein a lubricant passage supplying the lubricant held by the lubricant holding part to the inner face of the fixing belt is formed in the substrate.

2. A fixing apparatus according to claim 1, wherein the lubricant passage is positioned on an upstream side of the heating element in a paper conveyance direction.

3. A fixing apparatus according to claim 1, wherein the lubricant passage is positioned on an upstream side and a downstream side of the heating element in a paper conveyance direction.

4. A fixing apparatus according to claim 1, wherein the lubricant holding part has a storage room formed between the sheet-shaped heater and the pushing member or in the part facing the sheet-shaped heater, of the pushing member, and the lubricant is stored in the storage room.

5. A fixing apparatus according to claim 4, wherein the storage room is formed by covering an opening of a concave part formed in a face facing the sheet-shaped heater, of the pushing member, with the substrate.

6. A fixing apparatus according to claim 4, wherein the lubricant passage is a hole penetrating the substrate or a notch formed in an end face of the substrate, and the hole or the notch is positioned at a position corresponding to the storage room.

7. A fixing apparatus according to claim 1, wherein the pushing member has a pillar part forming a skeleton of the pushing member and a belt supporting part covering the pillar part, the fixing belt is supported between the pressing member and the belt supporting part, the sheet-shaped heater is placed in the belt supporting part so as to be positioned between the fixing belt and the belt supporting part, and the lubricant holding part is formed in the belt supporting part so as to face the sheet-shaped heater.

8. An image forming apparatus comprising a fixing apparatus according to claim 1.
